(19) United States
(12) Patent Application Publication
(10) Pub. No.: US 2007/0193930 A1
(43) Pub. Date: Aug. 23, 2007

(54) Aqueous liquid clarification system

(76) Inventors: Taylor A. Marsh, Ormond Beach, FL (US); William J. Lorenzo, Ormond Beach, FL (US)

Correspondence Address: MILES & STOCKBRIDGE PC, 1751 PINNACLE DRIVE, SUITE 500, MCLEAN, VA, 22102-3833, US

(21) Appl. No.: 11/356,461

(22) Filed: Feb. 17, 2006

(51) Int. Cl. B01D 29/00

(52) U.S. Cl. 210/121; 210/241; 210/335; 210/258; 210/416.1

(57) ABSTRACT

Disclosed is an impure aqueous liquid clarification system comprising a first plurality of polyacrylamide-housing means, the polyacrylamide being capable of flocculating impurities in impure aqueous liquid, this first plurality of housing means being joined in series and a second plurality of filter-housing means, each being capable of filtering impurities from the flow of aqueous liquid that have been flocculated therein by contact with the polyacrylamide in the first plurality of polyacrylamide-housing means, this second plurality of housing means being joined in series wherein, (a) the last of the polyacrylamide-housing means in the series of first plurality of housing means is joined in series to the first of the filter-housing means in the series of second plurality of housing means.

### BACKGROUND OF THE INVENTION

1. Field of the Invention

The invention relates to a system and methods for clarifying impure aqueous liquids.

2. Description of the Prior Art

The present invention relates to an improved system for removing turbidity-causing impurities from surface waters and other domestic and industrial water supplies containing such impurities.

Turbid water has a haziness caused by insoluble, suspended particles such as clay, silt, bacteria, viruses, organic debris resulting from the decay of plant life and similar materials present in the water. Turbidity standards have been established by governmental regulatory authorities for determining the water quality of municipal distribution facilities. With certain limited exceptions, a monthly average of one turbidity unit (TU) has been set as the maximum contaminant limit for turbidity. Turbidity measurements are made by determining the amount of light that is scattered by particulate matter in a sample of water.

Although water treatment for turbidity removal may vary depending on raw water quality, conventional systems generally involve pre-treatment including coagulation/flocculation and sedimentation, followed by filtration and chlorination.

Coagulation is ordinarily carried out in a rapid mixing tank by adding to the raw water a chemical agent which causes agglomeration of the suspended matter into larger particles that can settle to the bottom of a containment means. The agglomerated particles, or floc, are sometimes subjected to gentle agitation in order to form floc bundles large enough to settle rapidly. A separate flocculation tank is often provided for this purpose.

Sedimentation is the process by which floc is separated from water by precipitation and deposition, and depends on the effect of gravity on particles suspended in a liquid of lesser density. Sedimentation without pre-treatment is rarely adequate for clarification of turbid water, as it does very little for removal of such fine particulate substances as clay, bacteria and the like. Also, sedimentation results in sludge formation and thus requires means for disposal of the sludge.

After the impure water undergoes appropriate pre-treatment, it is clarified for the removal of suspended particles by passage through a porous medium. Most conventional water treatment systems employ granular media filtration. For example, rapid sand clarifiers and mixed media clarifiers (e.g. sand and particulate coal) have proved effective for reducing turbidity. However, granular media filtration virtually always requires chemical pre-treatment for effective turbidity removal. Slow sand clarifiers, which were among the first water treatment systems to be used for large scale filtration, have numerous shortcomings when it comes to treating turbid water, including low filtration capacity, channeling, and ease of clogging.

The cost of the space and equipment required for installation of a conventional water treatment system of the type described above is considerable, as is the continuing cost of operation and maintenance of such a system. Although efforts toward improving these prior art processes have continued, the improvements have related in general to enhancing floe formation and sedimentation, reducing the load on the clarifiers, and using larger grained sand and higher filtration rates as a means of reducing cost.

Alternative municipal water treatment processes employing clarifier-aid principles have been developed more recently to reduce the requirements for large and expensive vessels to provide for floc formation and sedimentation. These systems are commonly known as precoat filtration systems and consist essentially of a pressure vessel containing a porous septum which is coated on the upstream side with a powdered clarifier medium which forms the precoat clarifier cake. As water flows through the cake, the solid impurities present in the water are caught in the cake's small pores. In this system, additional clarifier aid is normally added to the body of the raw water in an amount sufficient for efficient and effective turbidity removal, the added clarifier aid being referred to as a body feed. The amount of body feed must be such as to prevent clarifier blinding and waste of precoat material resulting from short periods of operation. In general, optimum results are obtained using about 0.8% to 1.0% of body feed by weight, in accordance with the manufacturers' recommendations. The most widely used of the precoat clarifiers is the diatomaceous earth clarifier.

It has been reported that effective clarification and purification of turbid water may be achieved by precoat filtration, using relatively small amounts of diatomaceous earth as body feed, provided that chemical additives, namely flocculating agents and polyelectrolytes, are added to the raw water with the body feed. See, U.S. Pat. No. 3,227,650. Apparently, the use of polyelectrolytes in this patented process is essential, for if a flocculating agent alone is used in conjunction with the diatomaceous earth, the water is practically unclarifiable. Further, it has been found that if diatomaceous earth alone is used as the precoat and body feed, the filtrate, while reduced in turbidity, is unacceptable for potable or industrial use.

While recent developments in the art have eliminated some of the cost of installation and equipment maintenance, the overall operating cost of municipal water treatment remains relatively high. In short, the cost of water treatment, whether by conventional systems or by systems operating on the clarifier aid principle, makes it uneconomic for many smaller applications. Hence, the development of an efficient and effective process for clarifying water at a reasonable cost continues to be a highly desired objective.

The present invention is predicated on the discovery that a mass of polyacrylamide is an excellent and very efficient water clarifier material or medium, particularly in the case of clarifying particulate matter from aqueous media.

Polyacrylamide has long been known to be useful as a flocculent or coagulant in liquid purification systems and methods. Human intervention for the intentional coagulation of impurities in water to aid in their removal is reported as early as 2000 BC by Romans and Egyptians using alum (Faust and Aly, 1998). Pliny, 77 AD, reported the use of a mixture of lime and alum for water clarification. Alum became an important item of trade in these early years mainly for leather treatment and as a dye mordant. By 1757, muddy water was being clarified in the UK using alum followed by filtration of the supernatant.

Aluminum and ferric salts have dominated the inorganic coagulant market due to their inherent hydrolysis yielding highly cationic oligomers. Intentionally prepolymerized versions, polyaluminum chloride (PAC) and polyferric sulfate (PFS) are important developments from the simple salts and were patented in Japan in 1972 and 1976 respectfully. Both have the advantage of being less pH dependent than their simple salts.

The use of lime in mineral processing is a panacea. It coagulates, depresses iron sulfides, and keeps cyanide in solution and caustisizes by removing carbonate ions. Early hard rock base metal tailings relied on lime as the coagulant during thickening and the early thickener sizing methods were developed using limed pulps.

Whereas inorganic salts promote coagulation by charge neutralization and double-layer compression, organic polymers promote solid-liquid separation by the bridging mechanism sometimes in combination with charge patch effects.

Polymers derived from plant-based materials were the first flocculants. Sanskrit writings in India dating from several centuries BC make reference to seeds of the Nirmali nut tree, Strychnos potatonim, as a clarifier. Peruvian texts from the 16th and 17th Centuries describe the use by sailors of powdered, roasted grains of Zea mays (corn starch) as a means of settling impurities. More recently, Chilean folklore texts from the 19^{th} Century refer to water clarification using the sap from the ‘tuna’ cactus (Opuntiafiscus indica). Isinglass, produced from fish swim bladders, has been used as finings for centuries for clarifying beer. The principal reactive constituent of isinglass is collagen. Collagen is a unique molecule that exists as a triple helix with three chains of amino acids wound around each other and held in place by complex hydrogen bonding. It is amphoteric but functions as a cationic polymer when removing yeast particles.

Naturally derived polymers that were used extensively as flocculants in mineral processing included animal glue, gelatin, starch and guar gum. Glue and gelatin are derived from collagen-bearing materials like bones and hides; they were used extensively in acidic hydrometallurgical operations like uranium extraction and were particularly effective at removing colloidal silica. Both starch and guar remain in niche applications, the former in alkaline environments like the Bayer Process and the latter in acidic operations like uranium filtration. Both starch and guar find application as flotation depressants.

The major limitation to the performance of naturally derived flocculants is their ceiling in molecular weight or effective chain length. For gelatin/glue the maximum is approximately 300,000, for guar approximately 250,000 and amylose starch 65,000 although amylopectin fractions are higher. Potato and tapioca starches have higher molecular weights than cornstarch.

A major advancement was seen in the 1950s when polyacrylamide flocculants were introduced. Early reference is made to application in water treatment in 1958 and they were certainly being used in the mineral processing industry in the early 1960s.

The polyacrylamide molecule could be tailored to virtually every mineral processing situation and the next four decades saw massive expansion in its use. By functional substitution to the polyacrylamide chain, the addition of cationic and anionic polyelectrolytes covered all slurry environments from mono-mineralic to multimineralic, low to high-suspended solids, low to high dissolved solids and low to high pH. Manipulation of molecular weight from 5 million to 25 million allowed successful application to be made on all solid-liquid separation equipment, clarifiers, thickeners, clarifiers of all types and centrifuges. Along with the polyamine and polyDADMAC primary coagulants, polyacrylamide-based flocculants account for over 90% of the mineral processing flocculent market.

Solid-liquid separation equipment, separation science and flocculants have shown parallel development. Notable synergy is seen between high molecular weight flocculants and high rate thickeners, especially with the development of addition of dilution water to feedwells allowing the most to be made of the powerful polymers.

Typically, polyacrylamide in powder form is added to a flow of water containing sediment or other undesirable impurities. The polyacrylamide operates to flocculate or coagulate the impurities which then settle out by gravity from the flowing water or are removed employing some sort of porous clarifier. An improved water clarification system employing polyacrylamide is described in copending application Ser. No. 10/460,668. The system disclosed in the application comprises a clarifier system, preferably portable, which is easily installed where needed to clarify a stream or body of water. The preferred clarifier comprises a lightweight housing having an impure water inlet side and a clarified water outlet side. If suitable, the system is located such that a stream of water to be clarified enters the inlet side of its own force and emerges in a clarified state from the outlet side.

### SUMMARY OF THE INVENTION

The present invention represents an improvement over the system described in application Ser. No. 10/460,668

One embodiment of the invention comprises an impure aqueous liquid clarification system comprising a first plurality of polyacrylamide-housing means, each being capable of accommodating a flow of impure aqueous liquid and at least one mass of solid polyacrylamide, the polyacrylamide being capable of flocculating impurities in the impure aqueous liquid with which it comes into contact, the first plurality of housing means being joined in series by connection means capable of transmitting the flow of impure aqueous liquid sequentially from the first of the of the housing means through each of the following housing means in the series to the last of the polyacrylamide-housing means and a second plurality of filter-housing means, each being capable of accommodating the flow of impure aqueous liquid requiring clarification and at least one filtering means capable of filtering impurities from the flow of aqueous liquid that have been flocculated therein by contact with the polyacrylamide in the first plurality of polyacrylamide-housing means, the second plurality of housing means being joined in series by connection means capable of transmitting the flow of aqueous liquid sequentially from the first of the housing means through each of the following housing means in the series to the last of the filter-housing means, wherein, (a) the last of the polyacrylamide-housing means in the series of first plurality of housing means is joined in series to the first of the filter-housing means in the series of second plurality of housing means by connection means capable of transmitting the flow of aqueous liquid to the first filter-housing means through to the last filter-housing means and (b) the first and second plurality of housing means are attached to the upper surface of a rigid base support.

### BRIEF DESCRIPTION OF THE DRAWINGS

FIG. 1 is a side elevational view of a system according to the invention.

FIG. 2 is a top elevational view of the system of FIG. 1.

FIG. 3 is a side elevational view of one of the polyacrylamide-housings of the system of FIG. 1.

FIG. 4 is a top elevational view of a cross-section of FIG. 3.

FIG. 5 is a top elevational view of FIG. 3 depicting the interiors of polyacrylamide-housings.

FIG. 6 is a top elevational view of a cross section of another polyacrylamide-housing.

FIGS. 7-9 are elevational views of cross-sections of filter-housings.

FIG. 10 is a side elevational view of a detail of FIG. 1.

FIG. 11 is an elevational view of a floating pump assembly

### DETAILED DESCRIPTION OF THE INVENTION

The invention will be described below with reference to the drawings for a preferred embodiment. It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown in the drawings and described in the specification.

A preferred application of the invention comprises the clarification of a body, e.g., a pond of turbid water that has collected as a result of run-off from, e.g., a construction site. However, it is to be understood that the system and method of the invention are applicable for the clarification of any type of body of water, whether a running or standing body of turbid water. In the drawings, the arrows depict the direction of water flow through the system of the invention.

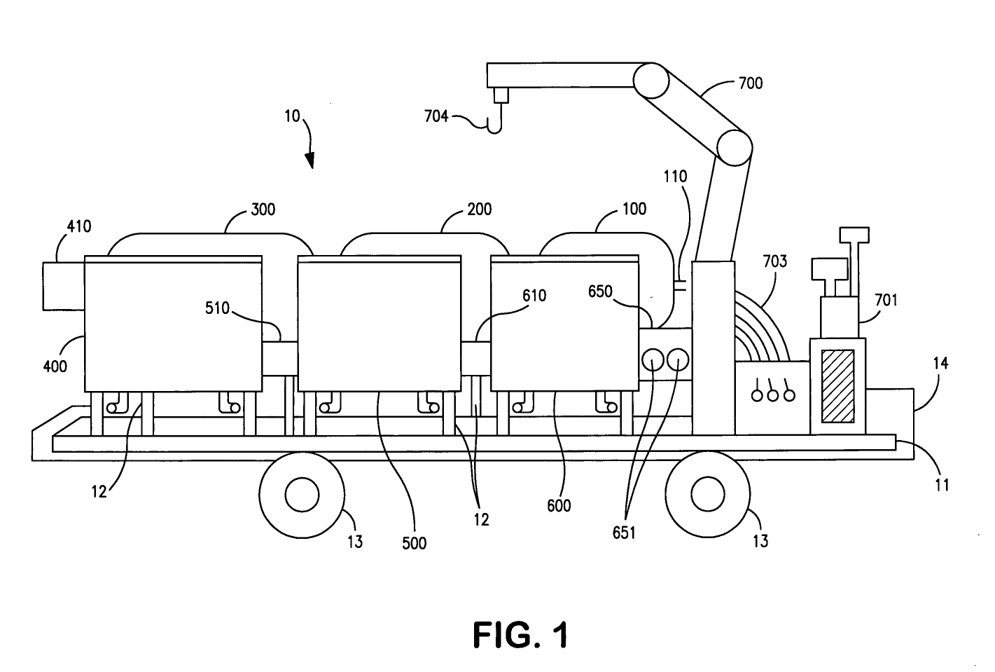

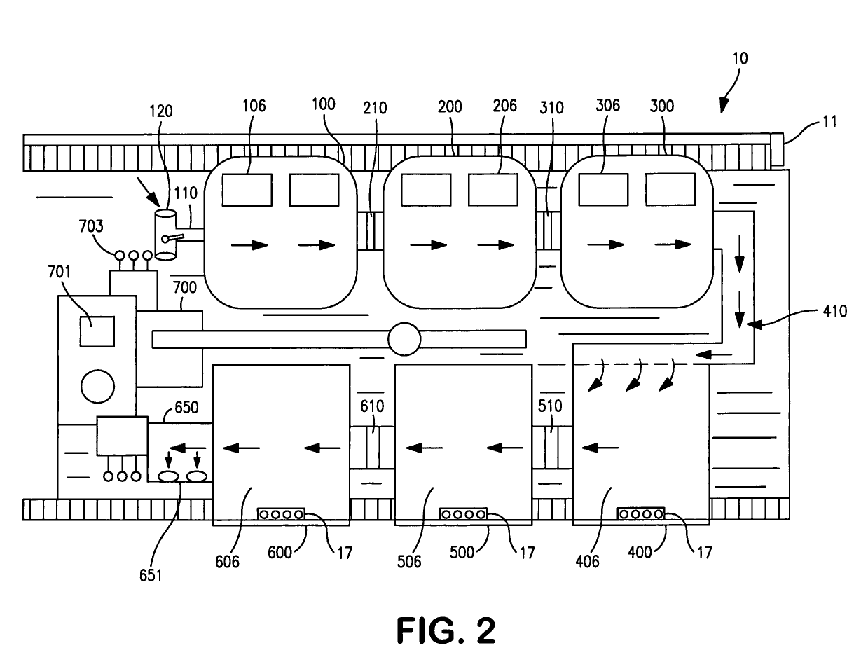

Referring to FIGS. 1-2, the clarification system 10 comprises a series of interconnected polyacrylamide-housings 100, 200 and 300 for accommodating a pressurized flow of turbid or impure water that enters the system via inlet 110 which is connected via connector 120 to a conduit (not shown) from the body of water to be clarified. In the embodiment shown, the water enters the system as a result of being pumped from a turbid pond (not shown) by a pump (also not shown). Each of the housings 100, 200 and 300 contain solid masses of polyacrylamide positioned therein so as to contact the turbid water as it is forced through the system by the pump. Contact with the polyacrylamide serves to flocculate at least some of the impurities contained in the water. The partly treated turbid water is forced through housing 100 and exits, then enters housing 200 via connector 210 where it contacts additional polyacrylamide, thereby flocculating additional impurities contained therein. The sequence is repeated when the further treated water exits housing 200 and enters housing 300 via connector 310. Preferably, polyacrylamide-housings 100, 200 and 300 are provided with lids 106, 206 and 306, respectively, to enable access to the interior thereof

It will be understood that additional polyacrylamide-housings may be positioned in the line, if desired; however, it is preferred to utilize three such polyacrylamide-housings to achieve optimum results.

The water containing flocculated impurities is then forced through connector 410 to the first of the filter-housings, 400. Therein, the fluid traverses a series of filter elements which permit passage of the water but retain thereon the flocculated impurities. The thus filtered fluid then enters, due to the pressure applied by the pump, filter-housing 500 via inlet 510. In filter-housing 500, the fluid is further contacted with an additional series of filters that remove still more flocculated impurities therefrom. After traversing housing 500, the fluid is forced into and through filter-housing 600 wherein it is submitted to a final filtering operation by a series of filters contained therein. Filter-housings 400, 500 and 600 are provided with hinged (17) lids 406, 506 and 606, respectively, to facilitate access to the interior thereof

Again, it will be understood that additional filter-housings may be positioned in the line, if desired; however, it is preferred to utilize three such filter-housings to achieve optimum results.

The clarified water then exits filter-housing 600 via outlet 650 wherein it is discharged from the system.

All of the polyacrylamide- and filter-housings are preferably rigidly attached to rectangular base support 11 by struts 12 to provide stable support for the system. It is preferred that the system be portable for ease of positioning near the body of turbid water to be clarified and for relocation to new positions. In a most preferred embodiment, base support 11 comprises the rectangular floor bed of a trailer 14 which is movable via wheels 13.

Although the various housings may be arranged in any desired fashion in order to achieve flocculation and removal of the turbidity-causing impurities, it is preferred that the housings be arranged in series as shown in FIGS. 1 and 2, i.e., wherein the first plurality of polyacrylamide-housing means is arranged longitudinally, in series, along one of the long sides of the rectangular base 11 and the second plurality of filter-housing means is arranged longitudinally along the opposite side of the rectangular base. More preferably, as shown in FIGS. 1 and 2 the pluralities of housing means are arranged such that the first of the polyacrylamide-housing means and the last of the filter-housing means are located nearer one of the short sides of the rectangular base 11 and the last of the polyacrylamide-housing means is joined in series to the first of the filter-housing means nearer the opposite short side of the rectangular base 11.

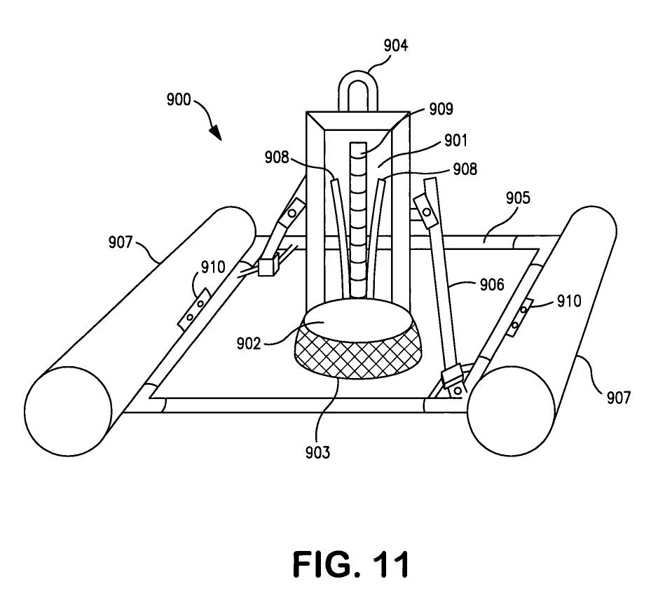

The water to be clarified is preferably transported to and through the system of the invention employing a floating pump assembly. Such floating pump assemblies are well known in the art and any suitable such pump may be used in the practice of the invention. A typical such pump assembly 900 is shown in FIG. 11 wherein pump 901 is depicted as supported by struts 906 on a platform 905 which is connected via connectors 910 to flotation devices 907. The assembly 900 is designed to float in the body of water to be clarified such that the pump head 902 is submerged to a depth sufficient to pump water in the body of water through conduit 909 to inlet 110 of polyacrylamide-housing 100. Preferably, a screen 903 is positioned over the pump head 902 to prevent large objects from being pumped in to the system of the invention. The pump may be powered by a power source 701 (FIGS. 1,2 and 10) connected thereto via power connectors 908. The floating pump assembly 900 is also preferably provided with attachment loop 904, by which it may be picked up and moved to another location on the body of water or removed altogether therefrom by a boom arm assembly (not shown) associated with the system of the invention.

Although a floating pump assembly has been depicted as the preferred means for delivering turbid water to the system of the invention, it will be understood by those skilled in the art that any suitable device capable of exerting sufficient fluid pressure to deliver the water to be clarified to and through the system may be employed in the practice of the invention.

As shown in FIGS. 1 and 2 it is also preferred to have a boom arm assembly 700 associated, preferably, firmly attached to and supported by base 11. The boom arm assembly is employed principally for lifting floating pump assembly 900 via hook means 704 which is adapted to engage attachment loop 904 of pump assembly 900. It will be understood by those skilled in the art that any conventional, suitable boom arm assembly may be employed in the practice of the invention. Preferably the boom arm assembly is an articulated, hydraulically-operated boom arm assembly. As depicted in FIGS. 1,2 and 10, the boom arm assembly is operated by the hydraulic line assembly 703 connected via power connector 702 to power source 701. Power source 701 is also preferably firmly attached to base 11 for stability purposes.

Although boom arm assembly 700 has been shown for the purpose of positioning the floating pump assembly 900, it will be understood by those skilled in the art that any suitable device may be employed for this purpose without departing from the scope of the invention.

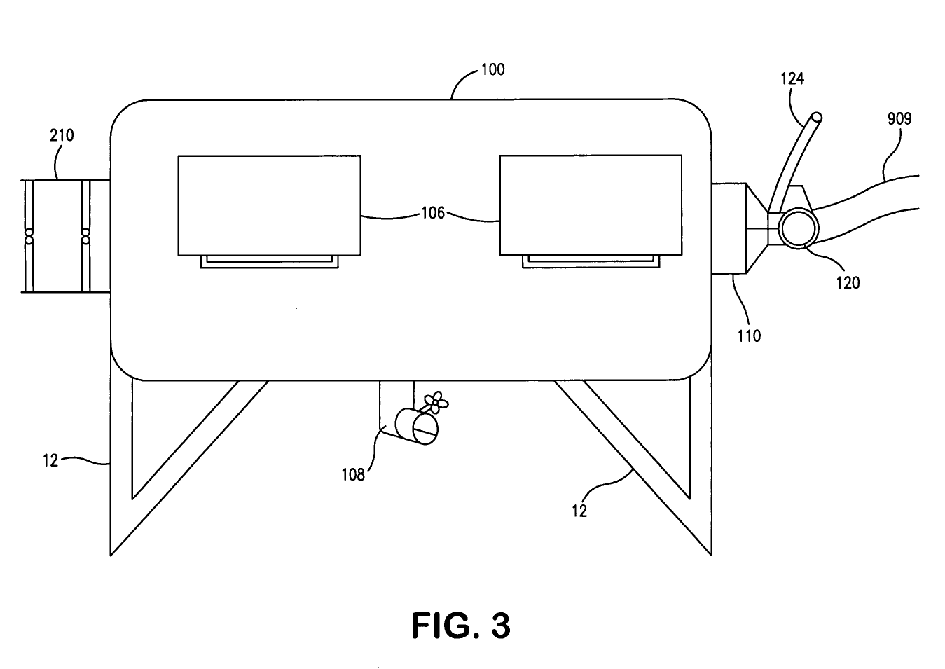

The polyacrylamide-housings and the function thereof are described in greater detail hereinafter with special reference to FIGS. 3-6.

Referring to FIG. 3, first polyacrylamide-housing 100 is equipped with impure water inlet 110. The water is conveyed from the impure water source via conduit 909 which is connected to inlet 110 via connector 120. The connection is provided with snorkel means 124 for the purposes of regulating air inlet and water pressure. The housing 100 is also outfitted with lids 106 to gain access to the interior thereof and struts 12 to stabilize the housing on the base deck (not shown). Housing 100 is also provided with outlet 108 for the removal from the bottom thereof of sediment that collects during the practice of the invention. Housing 100 is provided with outlet 210 for transmitting water that has run therethrough to housing 200 (not shown).

Polyacrylamide-housings 100, 200 and 300 are preferably cylindrical in shape as shown in the drawings since that configuration provides optimum clarification of the impure water. It will be understood by those skilled in the art, however, that any suitable configuration may be employed for this purpose without departing from the scope of the invention.

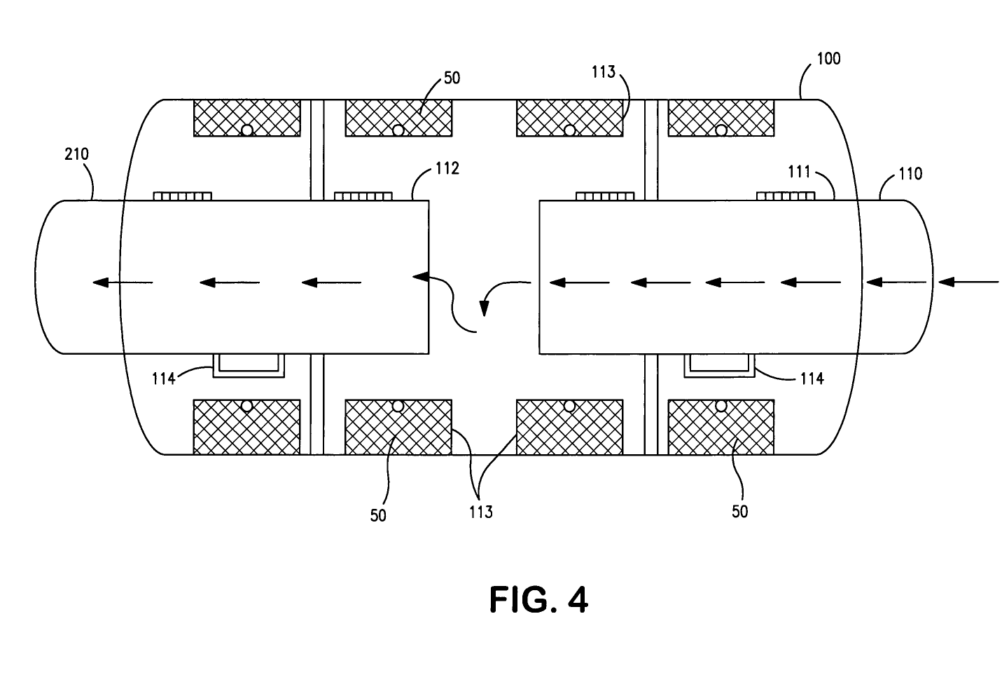

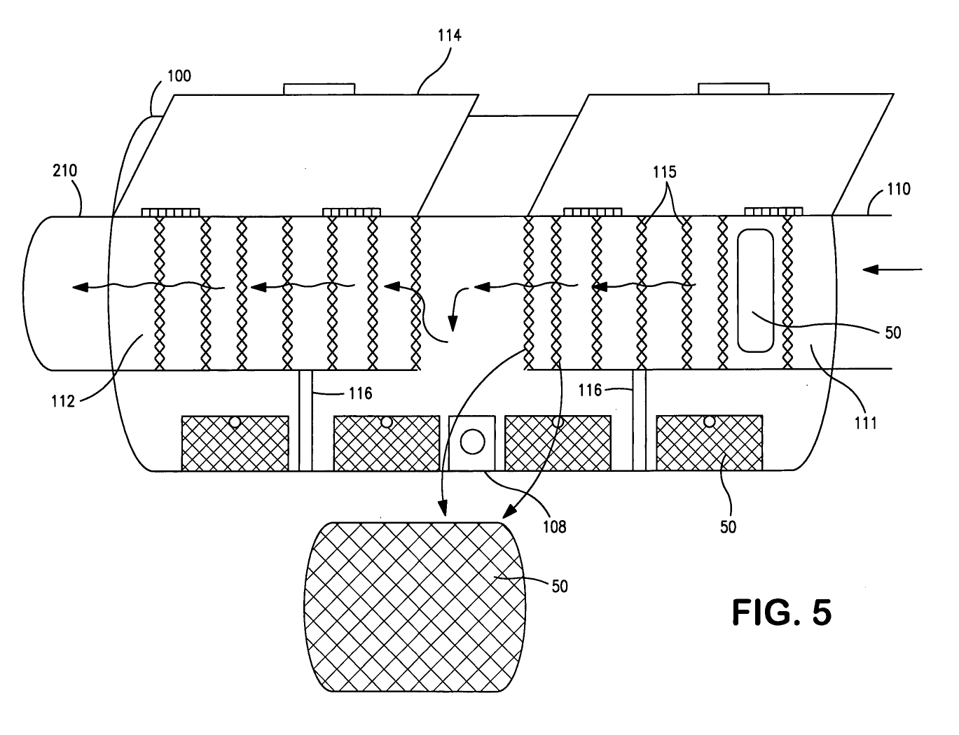

Most preferably, as best seen in FIGS. 4 and 5, all of the polyacrylamide-housings (100 and 200) except the last one in the series (300) contain within them preferably rectangular interior housing-conduits 111 and 112 (in 100) through which the impure water flows from one polyacrylamide housing to the next, i.e., from 100 to 200. The rectangular conduit is rigidly supported within the polyacrylamide-housing and extends coaxially within the polyacrylamide-housing through the cylindrical tanks, at least to the entrance of the last cylindrical tank. Rectangular conduit 111,112 contains porous screen-type elements 115 adapted to releasably house solid masses of polyacrylamide 50 and to allow passage therethrough of the impure aqueous liquid in contact with each element of polyacrylamide 50 into the last cylindrical tank.

The rectangular housing conduit is rigidly supported within the cylindrical tanks by struts 116 such that a substantially open space exists between all of the outer walls of the rectangular housing conduit and the inner walls of the cylindrical tanks.

Preferably the rectangular housing conduit is divided into first and second coaxially extending sections 111 and 112 so as to provide an open space therebetween and to allow impure aqueous liquid entering the open space from the first section 111 to at least partially spill into the cylindrical tank 100, and at least partially fill and circulate within the cylindrical tank 100 before exiting the tank through said second section 112. The interior walls of cylindrical tank 100 are also preferably fitted with a plurality of porous screen-type cages 113 for releasably housing polyacrylamide masses 50 through which the impure water spilling into the interior of the cylindrical tank from first section 111 passes to facilitate additional flocculation of impurities before exiting through second section 112.

It will be understood that sections 111 and 112 may be joined to form one continuous rectangular housing conduit and that the two section element (111 and 112) is shown as the preferred embodiment. Moreover, it will also be understood that cylindrical tank 200 and any additional cylindrical tanks, except, optionally, the last one may be identically constructed. Rectangular housing conduits 111 and 112 are provided with lids 114 to allow access into the interior thereof.

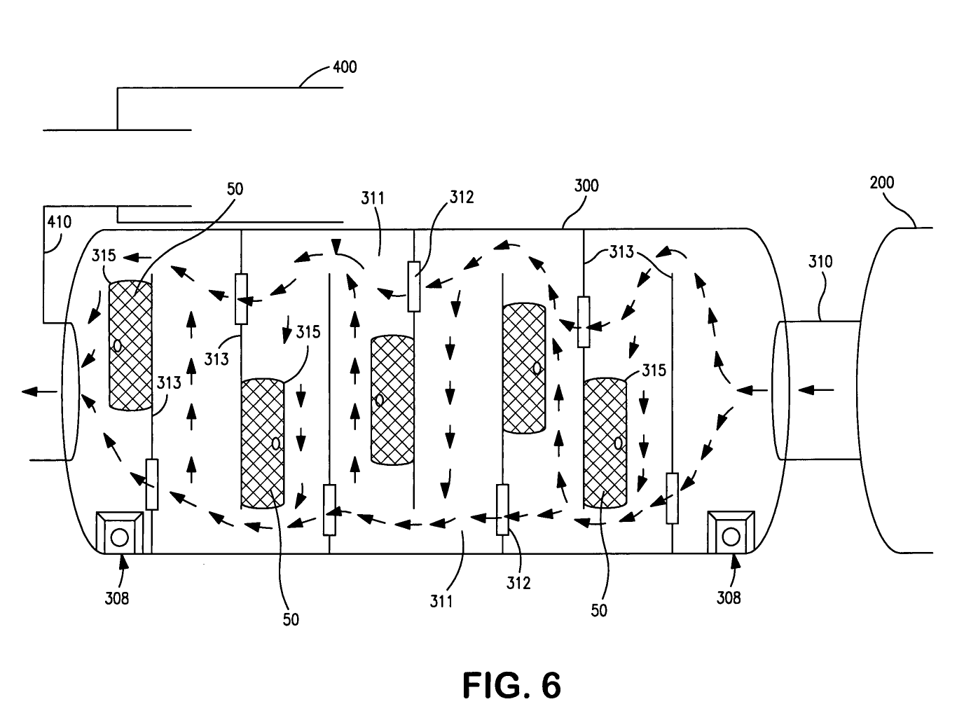

Optionally and preferably, the last cylindrical tank in the series is not constructed to house the above-described rectangular housing conduits. As shown in FIG. 6, it is preferred that the last tank 300 be divided into sections 311 by walls 313 which extend alternately from one cylindrical side of the tank toward the other leaving alternately spaced flow passages for the water on each side of the tank, as shown. The walls 313 are provided with holes 312 near the walls from which they extend to provide alternately spaced flow passages on those sides as shown. The walls 313 are provided with porous screen elements 315, each releasably containing solid polyacrylamide 50 for contact with the water flowing therethrough as in tanks 100 and 200. The bottom of tank 300 is also provided with outlets 308 for releasing sediment therefrom. Tank 300 is constructed as depicted in FIG. 6. i.e., is transversely divided by liquid flow diverting walls 313, provided with holes 312, to force a tortuous flow of impure aqueous liquid from inlet 310 from tank 200 therethrough to outlet 410 to first filter-housing 400, thereby ensuring maximum contact between the impure water and the polyacrylamide flocculent.

Filter-housings 400, 500 and 600 are preferably rectangular in shape as shown in the drawings since that configuration provides optimum clarification of the impure water. It will be understood by those skilled in the art, however, that any suitable configuration may be employed for this purpose without violating the spirit of the invention.

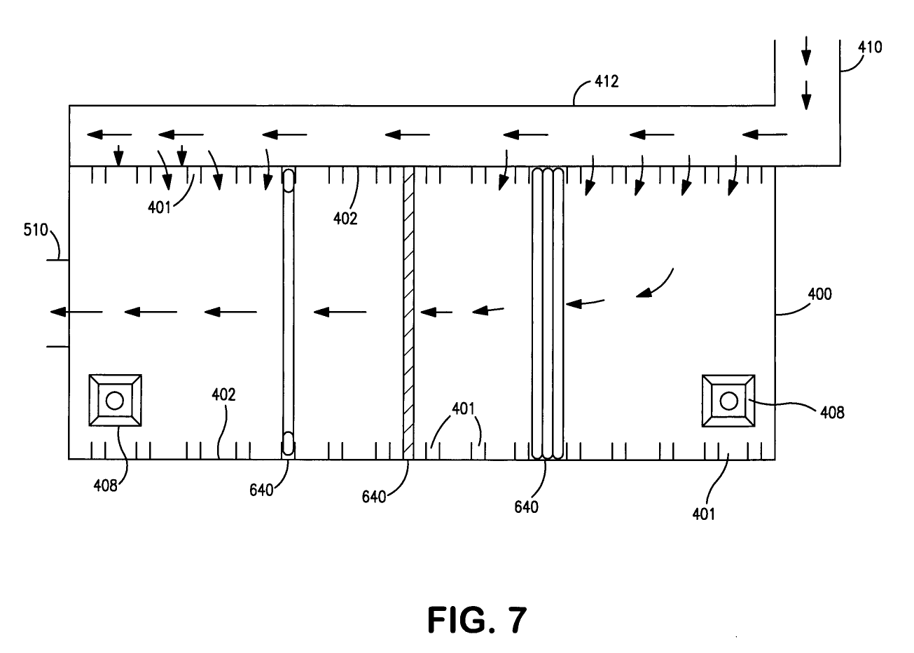

As shown in FIG. 7, impure, flocculant containing water flows from outlet 410 from polyacrylamide-housing 300 into filter-housing 400. Optionally, and preferably, this first filter-housing 400 that the water enters is constructed as shown in FIG. 7. The impure water enters filter-housing 400 from outlet 410 into trough 412 that runs along the top of filter-housing 400. The bottom surface of the trough 412 is provided with holes (not shown) that allow the impure water to fall by gravity in waterfall fashion into the interior of housing 400. The pressure exerted by the pump 900 forces the water through filter housing 400 in the direction depicted by the arrows. The filter-housing 400 is provided with multiple brackets 401 on opposing perpendicular walls 402 aligned with each other and spaced for releasably installing multiple individual filter means 640 that are positioned transverse to the flow of impure aqueous liquid therein. After operation of the system for a predetermined length of time, the filters 640 are removed, cleared of flocculated impurities and reinserted into brackets 401 for further filtering of the water flow. The bottom of housing 400 is provided with sediment outlets 408. The water flow that has been at least partially filtered in housing 400 flows through outlet 510 to the next filter-housing in line.

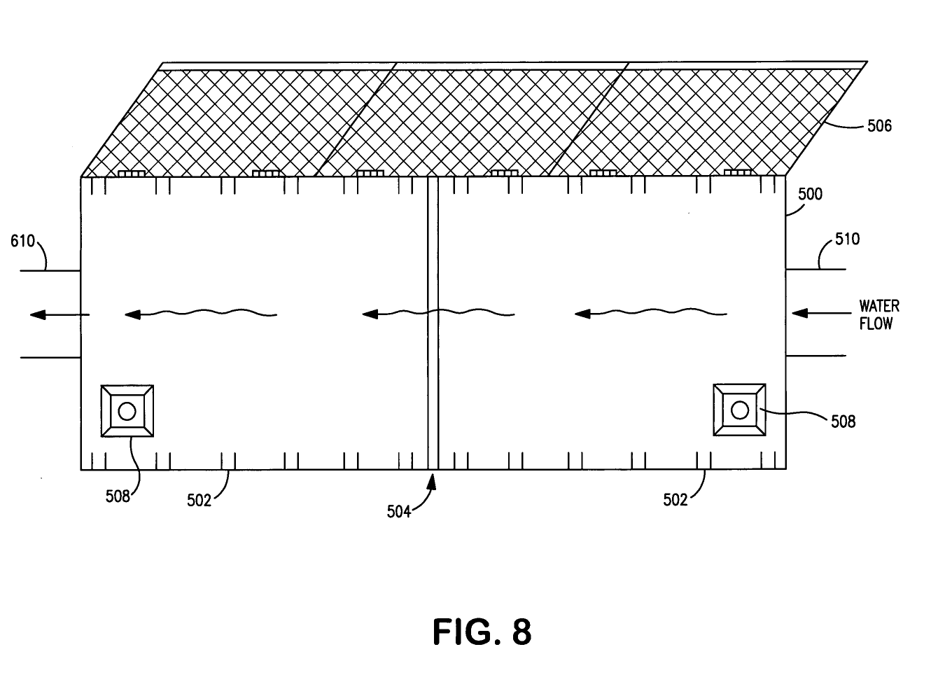

The next housing filter in line, 500, is constructed similarly to housing 400 except that the incoming water does not enter via a trough. Instead, as shown in FIG. 8 the partially filtered water enters filter housing 500 via outlet 510 from housing 400 and flows under pressure as described above in the direction of the arrows through filters 504, releasably mounted in brackets 502 so as to be transverse to the flow of water through housing 500. Lid 506 is provided for access to the interior of the housing. Sediment-releasing outlets 508 are provided at the bottom of the housing. After further filtration in housing 500, the water flows through outlet 610 into the next filter housing in line.

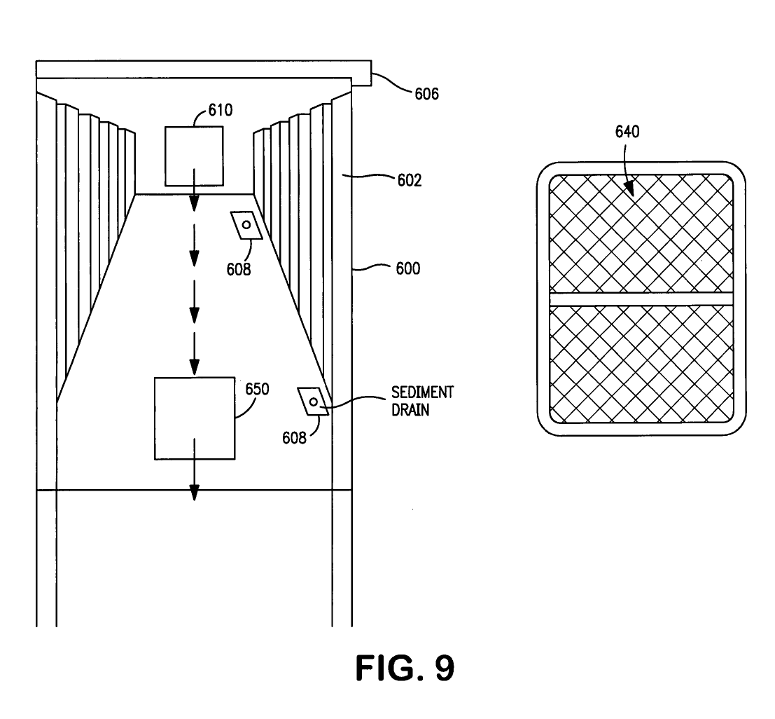

The thusly further purified water then flows through outlet 610 from housing 500 to filter housing 600 as shown in FIG. 9, which is constructed similarly to housing 500. Housing 600 is provided with brackets 602 designed to releasably position filter elements 640 transverse to the flow of water in housing 600. The clarified water exits the system via outlet 650. The housing is provided with a lid 606 for interior access and sediment releasing outlets 608.

It will be understood by those skilled in the art that any suitable filtering means may be employed in the practice of the invention. It is preferred to employ screen-type filters as depicted in FIG. 9 with openings therein of a size to trap the impurities in the water flocculated by the polyacrylamide but sufficiently large to allow optimum flow of water through the system. The filter screens are constructed so as to occupy substantially the entire planar rectangular area within the filter housings transverse to the flow of water therethrough. It will be understood by those skilled in the art that the rate of flow of water through the system of the invention is dependent upon multiple variables, including, but not limited to, the pressure generated by the pump 900, the number of polyacrylamide blocks in the polyacrylamide-housings 100, 200 and 300, the number of filters in filter housings 400, 500 and 600, the frequency of cleaning the filters, and the like.

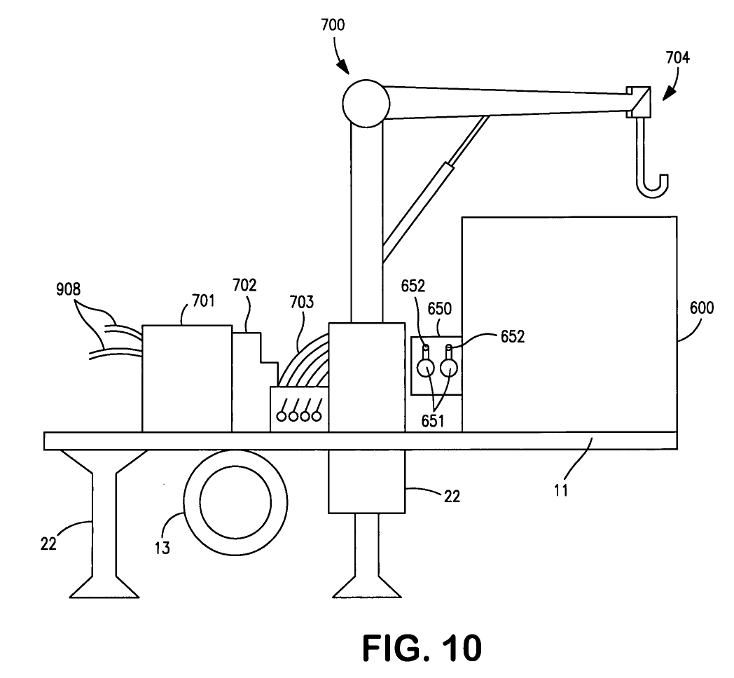

Referring to FIG. 10, boom arm assembly 700 engages and picks up pump 900 (FIG. 11) by means of hook 704 and positions the floating pump in its desired location in the body of water to be clarified (not shown). Impure water is transmitted under pressure to inlet means 110 (FIGS. 2 and 3) by the pump 900, which is powered by power source 701 through power connectors 908 (which also powers boom arm assembly 700 by means of power connector 702 and hydraulic lines 703). After passage through the system of the invention, the clarified water exits the system via outlet 650 from final filter housing 600. Outlet 650 is provided with connection elements 651 which may be connected to hoses for transmitting the water to any desired location, including the source of turbid water itself. The rate of exit of the clarified water may be regulated by valve means 652. If desired, extensible struts 22 may be positioned on the underside of base-deck 11 to raise the system to an elevation such that the wheels 13 of the trailer are off the ground and the system is further stabilized for operation.

The present invention is not limited to the above embodiments and various changes and modifications can be made within the spirit and scope of the present invention. Therefore to apprise the public of the scope of the present invention, the following claims are made.

1. An impure aqueous liquid clarification system comprising a first plurality of polyacrylamide-housing means, each being capable of accommodating a flow of impure aqueous liquid and at least one mass of solid polyacrylamide, said polyacrylamide being capable of flocculating impurities in said impure aqueous liquid with which it comes into contact, said first plurality of housing means being joined in series by connection means capable of transmitting said flow of impure aqueous liquid sequentially from the first of said of said housing means through each of the following housing means in said series to the last of said polyacrylamide-housing means and a second plurality of filter-housing means, each being capable of accommodating said flow of impure aqueous liquid requiring clarification and at least one filtering means capable of filtering impurities from said flow of aqueous liquid that have been flocculated therein by contact with said polyacrylamide in said first plurality of polyacrylamide-housing means, said second plurality of housing means being joined in series by connection means capable of transmitting said flow of aqueous liquid sequentially from the first of said housing means through each of the following housing means in said series to the last of said filter-housing means, wherein, (a) the last of said polyacrylamide-housing means in said series of first plurality of housing means is joined in series to the first of said filter-housing means in said series of second plurality of housing means by connection means capable of transmitting said flow of aqueous liquid to said first filter-housing means through to the last filter-housing means and (b) said first and second plurality of housing means are attached to the upper surface of a rigid base support.

2. The system of claim 1 wherein said polyacrylamide-housing means releasably accommodate said mass of solid polyacrylamide.

3. The system of claim 1 wherein said filter-housing means releasably accommodate said at least one filtering means.

4. The system of claim 1 wherein said first polyacrylamide-housing means is equipped with an inlet means for admitting therein said flow of impure aqueous liquid.

5. The system of claim 1 wherein said last filter-housing means is equipped with an outlet means for discharging therefrom a clarified flow of aqueous liquid.

6. The system of claim 5 wherein said outlet means is equipped with means for delivering said clarified aqueous liquid to the source of said impure aqueous liquid.

7. The system of claim 1 wherein said first plurality of polyacrylamide-housing means comprises three such housing means.

8. The system of claim 1 wherein said second plurality of filter-housing means comprises three such housing means.

9. The system of claim 1 wherein said rigid base is rectangular in shape and said pluralities of housing means are attached to the upper surface thereof.

10. The system of claim 9 wherein the first plurality of polyacrylamide-housing means is arranged longitudinally, in series, along one of the long sides of said rectangular base and the second plurality of filter-housing means is arranged longitudinally, in series, along the opposite side of said rectangular base.

11. The system of claim 10 wherein the said pluralities of housing means are arranged such that the first of the polyacrylamide-housing means and the last of said filter-housing means are located nearer one of the short sides of said rectangular base and the last of said polyacrylamide-housing means is joined in series to the first of the filter-housing means nearer the opposite short side of the rectangular base.

12. The system of claim 1 associated with means for transmitting and for producing sufficient pressure to force said flow of impure aqueous liquid into, through and out of said pluralities of housing means.

13. The system of claim 12 wherein said means for introducing said flow of impure aqueous liquid is connected to the inlet means of said first polyacrylamide-housing.

14. The system of claim 12 wherein said pressure producing means is a pump.

15. The system of claim 14 wherein said pump is a floating pump assembly means capable of floating in a body of impure aqueous liquid and delivering said impure aqueous liquid to and through said pluralities of housings.

16. The system of claim 15 associated with a boom arm assembly adapted for positioning said floating pump assembly means.

17. The system of claim 16 wherein said boom arm assembly is an articulated, hydraulically-operated boom arm assembly.

18. The system of claim 16 wherein said boom arm assembly is attached to said rigid base.

19. The system of claim 18 wherein said boom arm assembly is attached to said rigid base at or near the short end of said rectangular base adjacent said first of the polyacrylamide-housing means and last of the filter-housing means.

20. The system of claim 1 wherein said base is portable.

21. The system of claim 20 wherein said portable base is equipped with wheels to facilitate transport.

22. The system of claim 21 wherein said portable base equipped with wheels comprises a trailer.

23. The system of claim 1 wherein the polyacrylamide-housing means are cylindrical tanks.

24. The system of claim 23 wherein at least one of said cylindrical tanks rigidly supports therein a coaxial rectangular conduit that longitudinally extends completely through said at least one cylindrical tank; said rectangular conduit being adapted to releasably house therein solid polyacrylamide and to conduct said impure aqueous liquid therethrough such that said aqueous liquid contacts said solid polyacrylamide.

25. The system of claim 24 wherein said rectangular conduit is rigidly supported within said at least one cylindrical tank such that a substantially open space exists between the outer walls of the rectangular tank and the inner walls of the cylindrical tanks.

26. The system of claim 24 wherein, within the at least one cylindrical tank, the rectangular conduit is divided into two coaxially extending first and second sections so as to provide an open space therebetween such as to allow impure aqueous liquid entering said open space from said first section to at least partially spill into said at least one cylindrical tank, at least partially fill and circulate in said at least one cylindrical tank before exiting the tank through said second section.

27. The system of claim 24 wherein said rectangular conduit is transversely divided with means for releasably housing individual masses of solid polyacrylamide and permitting impure aqueous liquid to travel through said conduit in contact with said solid polyacrylamide.

28. The system of claim 27 wherein said means for housing polyacrylamide are screens positioned transverse to the flow of water in said rectangular conduit and dividing said conduit into sections releasably accommodating said solid polyacrylamide.

29. The system of claim 24 wherein said at least one cylindrical tank containing said rectangular conduit contains means for releasably housing additional solid polyacrylamide to contact the impure aqueous liquid circulating therein.

30. The system of claim 23 wherein said last cylindrical tank is transversely divided by liquid flow diverting means to force a tortuous flow of impure aqueous liquid therethrough.

31. The system of claim 30 wherein said last cylindrical tank is provided with housing means releasably containing masses of solid polyacrylamide at locations such that said impure aqueous liquid is forced into contact therewith during its tortuous flow therethrough.

32. The system of claim 23 wherein at least one of said cylindrical tanks is equipped with lid means for accessing the interior thereof.

33. The system of claim 24 wherein at least one of said rectangular conduits is equipped with lid means for accessing the interior thereof.

34. The system of claim 1 wherein at least one of said polyacrylamide-housing means is provided at the bottom thereof with means for emptying sediment therefrom.

35. The system of claim 1 wherein at least one of said filter-housing means is provided at the bottom thereof with means for emptying sediment therefrom.

36. The system of claim 1 wherein said filter-housing means are substantially rectangular tanks wherein the connection means for transmitting impure aqueous liquid therethrough are located at the opposing faces of least surface area.

37. The system of claim 36 wherein said rectangular filter-housing means are provided with means on opposing perpendicular side walls thereof spaced for releasably installing at least one filter means transverse to the flow of impure aqueous liquid therein.

38. The system of 36 wherein said rectangular filter-housing means are provided with multiple means on opposing perpendicular side walls thereof spaced for releasably installing therein multiple filters that extend across substantially the entire planar surface area transverse to the flow of impure aqueous liquid therein.

39. The system of claim 1 wherein said filters are capable of filtering impurities flocculated from the flow of impure aqueous liquid by contact with said solid polyacrylamide.

40. The system of claim 1 wherein said first filter-housing means is provided at the top thereof with a trough extending the longitudinal length of said rectangular housing means, said trough being connected to said connection means for transmitting said impure aqueous liquid from said last polyacrylamide-housing means to said first filter-housing means, and said trough containing openings therein such that said impure aqueous liquid is transmitted to the interior of said filter housing means in waterfall fashion by the force of gravity.

41. The system of claim 1 wherein the underside of said base is equipped with rigid support means for elevating said system a desired distance and at a desired configuration.

42. The system of claim 1 associated with a power source capable of powering said boom arm assembly.

43. The system of claim 1 associated with a power source capable of powering said pump means.

44. The system of claims 42 and 43 wherein both power sources are one and the same.

45. In a method of clarifying an impure aqueous liquid to remove undesirable impurities therefrom, the improvement comprising employing the clarification system of claim 1.
